(19) United States
(12) Patent Application Publication
(10) Pub. No.: US 2006/0271607 A1
(43) Pub. Date: Nov. 30, 2006

(54) Diagnostic imaging apparatus and program

(75) Inventor: Tsutomu Yawata, Tokyo (JP)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: GE Medical Systems Global Technology Company, LLC

(21) Appl. No.: 11/439,020

(22) Filed: May 23, 2006

(30) Foreign Application Priority Data
May 30, 2005 (JP) 2005-158040

(51) Int. Cl. G06F 17/30

(52) U.S. Cl. 707/204

(57) ABSTRACT

A diagnostic imaging apparatus which stores in a main storage device files containing image data, generated on the basis of signals from a subject, regarding the subject. The diagnostic imaging apparatus includes an auxiliary storage device provided separately from the main storage device, a backup judgment device which judges whether or not a part or the whole of a group of the files stored in the main storage device is to be backed up in the auxiliary storage device, and a backup device which, when this backup judgment device has judged that backup is to be performed, transmits and records a part or the whole of the group of the image files stored in the main storage device to and in the auxiliary storage device and erases the image files recorded in the auxiliary storage device from the main storage device.

### CROSS REFERENCE TO RELATED APPLICATIONS

This application claims the benefit of Japanese Application No. 2005-158040 filed May 30, 2005.

### BACKGROUND OF THE INVENTION

The present invention relates to a diagnostic imaging apparatus such as an ultrasound diagnostic apparatus, X-ray CT apparatus or MRI apparatus and a program therefore.

As disclosed in Patent Document 1, in a diagnostic imaging apparatus such as an ultrasound diagnostic apparatus, image files composed of patient information, diagnostic images, image pickup conditions and the like are stored and held in a hard disk device, which is the main storage device disposed inside the apparatus.

However, as patients and their diagnostic images increase, the load imposed on the capacity of the hard disk device may invite a problem of deterioration in system performance. Especially, since an ultrasound diagnostic apparatus, unlike an X-ray CT apparatus or MRI apparatus which is stationarily installed for use in a prescribed place, is often designed to be movable, it is not connected to a server apparatus all the time, and therefore it is more susceptible to give rise to a problem of deterioration in system performance.

For this reason, with a view to avoiding such a situation, the user is urged to perform periodic backing-up of files in the hard disk device and to have various storage media back up file data in the hard disk device.

[Patent Document 1] JP-A No. 2001-128969

However, requiring the user to perform periodic backing-up of files in the hard disk device means forcing of troublesome periodic backing-up on the user, giving rise to a problem of deteriorated working efficiency of the like.

### SUMMARY OF THE INVENTION

Therefore, an object of the present invention is to provide a diagnostic imaging apparatus and program permitting, without forcing the user to perform troublesome periodic backing-up, a part or the whole of a group of image files stored in the main storage device automatically in an auxiliary storage device and at the same time preventing the system performance from deterioration by reducing the load on the main storage device.

In order to the solve the problem stated above and achieve the object, in a diagnostic imaging apparatus according to a first aspect of the invention which stores in a main storage device files containing image data, generated on the basis of signals from a subject, regarding the subject, it is equipped with an auxiliary storage device provided separately from the main storage device; a backup judgment means which judges whether or not a part or the whole of a group of the files stored in the main storage device is to be backed up in the auxiliary storage device; and a backup means which, when this backup judgment means has judged that backup is to be performed, transmits and records a part or the whole of the group of the image files stored in the main storage device to and in the auxiliary storage device and erases the image files recorded in the auxiliary storage device out of the main storage device.

In this diagnostic imaging apparatus according to the first aspect of the invention, when the backup judgment means has judged that backup is to be performed, a part or the whole of the group of the image files stored in the main storage device is transmitted and recorded to and in the auxiliary storage device provided separately from the main storage device, the image files recorded in the auxiliary storage device are erased out of the main storage device. This makes it possible, without forcing the user to perform troublesome periodic backing-up, to back up a part or the whole of a group of image files stored in the main storage device automatically in the auxiliary storage device and at the same time to prevent the system performance from deterioration by reducing the load on the main storage device.

A diagnostic imaging apparatus according to a second aspect of the invention is further provided with backup notification means which, when the backup judgment means has judged that backup is to be performed, gives a notification to the effect that a part or the whole of the group of the image files stored in the main storage device will be backed up.

In the diagnostic imaging apparatus according to the second aspect of the invention, when the backup judgment means has judged that backup is to be performed, the user can be made aware of the execution of a backup operation by giving a notification to the effect that a part or the whole of the group of the image files stored in the main storage device will be backed up.

A diagnostic imaging apparatus according to a third aspect of the invention is further provided with a monitoring means which monitors the available storage capacity in the auxiliary storage device; and a notification means which, when it is judged by this monitoring means that the available storage capacity in the auxiliary storage device has become scarce, gives a notification to the effect that the available storage capacity in the auxiliary storage device has become scarce.

In the diagnostic imaging apparatus according the third aspect of the invention, the available storage capacity in auxiliary storage device is monitored and, when it is judged that the available storage capacity in the auxiliary storage device has become scarce, it is possible to avoid a situation in which neither a part of nor the whole of the group of image files stored in the main storage device cannot be backed up in the auxiliary storage device by giving a notification to the effect that the available storage capacity in the auxiliary storage device has become scarce.

In a diagnostic imaging apparatus according to a fourth aspect of the invention, the backup judgment means judges whether or not a part or the whole of the group of the image files stored in the main storage device is to be backed up in the auxiliary storage device according to whether or not the total number of subjects pertaining to the image files stored in the main storage device exceeds the threshold thereof.

In the diagnostic imaging apparatus according to the fourth aspect of the invention, by judging whether or not a part or the whole of the group of the image files stored in the main storage device is to be backed up in the auxiliary storage device according to whether or not the total number of subjects pertaining to the image files stored in the main storage device exceeds the threshold thereof, secure backup operation can be realized.

In a diagnostic imaging apparatus according to a fifth aspect of the invention, the backup judgment means judges whether or not a part or the whole of the group of the image files stored in the main storage device is to be backed up in the auxiliary storage device according to whether or not the used data capacity of the main storage device exceeds the threshold thereof.

In the diagnostic imaging apparatus according to the fifth aspect of the invention, by judging whether or not a part or the whole of the group of the image files stored in the main storage device is to be backed up in the auxiliary storage device according to whether or not the used data capacity of the main storage device exceeds the threshold thereof, secure backup operation can be realized.

In a diagnostic imaging apparatus according to a sixth aspect of the invention, the backup judgment means judges whether or not a part or the whole of the group of the image files stored in the main storage device is to be backed up in the auxiliary storage device according to whether or not the size of image data generated pertaining to the subject exceeds the threshold thereof.

In the diagnostic imaging apparatus according to the sixth aspect of the invention, by judging whether or not a part or the whole of the group of the image files stored in the main storage device is to be backed up in the auxiliary storage device according to whether or not the size of image data generated pertaining to the subject exceeds the threshold thereof, secure backup operation can be realized.

In a diagnostic imaging apparatus according to a seventh aspect of the invention, the auxiliary storage device can record into a detachably built-in portable recording medium; and the backup means records a part or the whole of the group of image files into the portable recording medium built into the auxiliary storage device.

In the diagnostic imaging apparatus according to the seventh aspect of the invention, the backup means can facilitate replacement and post-backup conservation when the available storage capacity in the auxiliary storage device has become scarce by recording a part or the whole of the group of image files into the portable recording medium detachably built into the auxiliary storage device.

A program according to an eighth aspect of the invention, which is readable by a computer for controlling a diagnostic imaging apparatus which stores in a main storage device files containing image data, generated on the basis of signals from a subject, regarding the subject, causes the computer to execute a backup judgment function to judge whether or not a part or the whole of a group of the files stored in the main storage device is to be backed up in an auxiliary storage device provided separately from the main storage device; and a backup function to transmit and record, when this backup judgment means has judged that backup is to be performed, a part or the whole of the group of the image files stored in the main storage device to and in the auxiliary storage device and to erase the image files recorded in the auxiliary storage device out of the main storage device.

By the program according to the eighth aspect of the invention, when the backup judgment means has judged that backup is to be performed, a part or the whole of the group of the image files stored in the main storage device is transmitted and recorded to and in the auxiliary storage device provided separately from and to erase the image files recorded in the auxiliary storage device out of the main storage device. This makes it possible, without forcing the user to perform troublesome periodic backing-up, to back up a part or the whole of a group of image files stored in the main storage device automatically in the auxiliary storage device and at the same time to prevent the system performance from deterioration by reducing the load on the main storage device.

A program according to a ninth aspect of the invention further causes the computer to execute a backup notifying function to give, when it has been judged by the backup judgment function that backup is to be performed, a notification to the effect that a part or the whole of the group of the image files stored in the main storage device will be backed up.

The program according to the ninth aspect of the invention, when it has been judged by the backup judgment function that backup is to be performed, can make the user aware of the execution of a backup operation by giving a notification to the effect that a part or the whole of the group of the image files stored in the main storage device will be backed up.

A program according to a 10th aspect of the invention further causes the computer to execute a monitoring function to monitor the available storage capacity in the auxiliary storage device; and a notifying function to give, when it is judged by this monitoring function that the available storage capacity in the auxiliary storage device has become scarce, a notification to the effect that the available storage capacity in the auxiliary storage device has become scarce.

The program according to the 10th aspect of the invention makes it possible to avoid a situation in which neither a part of nor the whole of the group of image files stored in the main storage device cannot be backed up in the auxiliary storage device by giving a notification to the effect that the available storage capacity in the auxiliary storage device has become scarce.

The diagnostic imaging apparatus and program according to the invention provides the effect of permitting, without forcing the user to perform troublesome periodic backing-up, a part or the whole of a group of image files stored in the main storage device to be backed up automatically in an auxiliary storage device and at the same time preventing the system performance from deterioration by reducing the load on the main storage device.

The diagnostic imaging apparatus and the program according to the invention is used for backing up image files composed of patient information, diagnostic images, image pickup conditions and the like and stored and held in the main storage device, and the invention is particularly suitable for a diagnostic imaging apparatus (e.g. an ultrasound diagnostic apparatus) not connected to a server apparatus all the time but designed to be movable.

Further objects and advantages of the present invention will be apparent from the following description of the preferred embodiments of the invention as illustrated in the accompanying drawings.

### BRIEF DESCRIPTION OF THE INVENTION

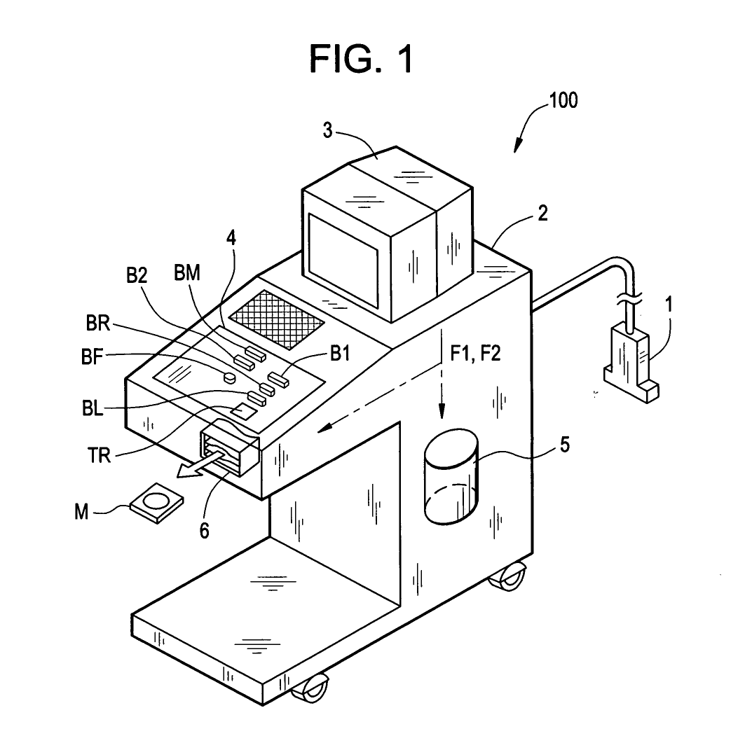

FIG. 1 is a perspective view schematically showing an ultrasound diagnostic apparatus in a mode for implementing the present invention.

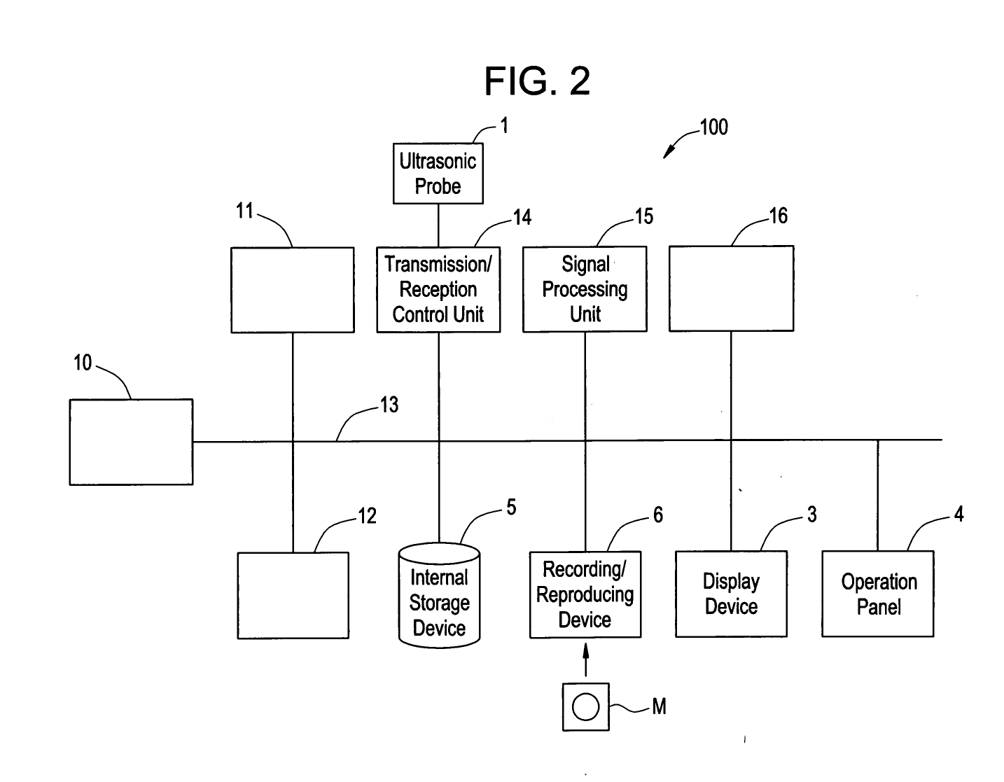

FIG. 2 is a block diagram showing the hardware configuration of each unit built into the ultrasound diagnostic apparatus.

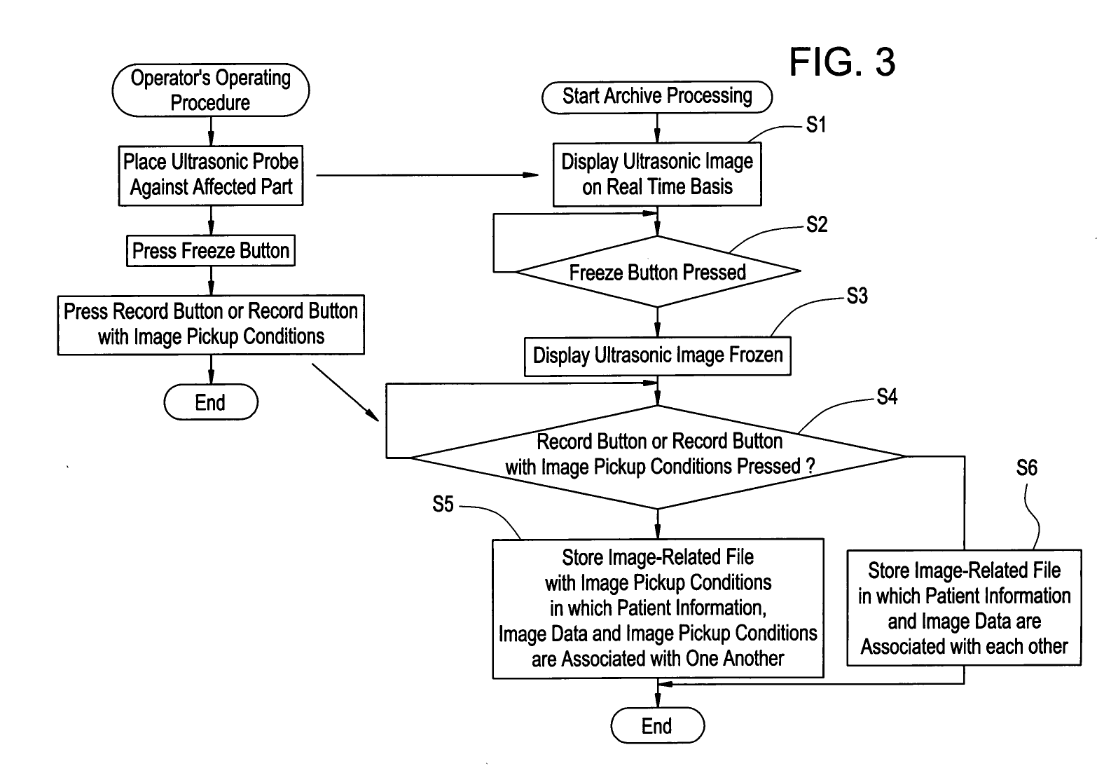

FIG. 3 is a block diagram showing the flow of archive processing of an ultrasonic image.

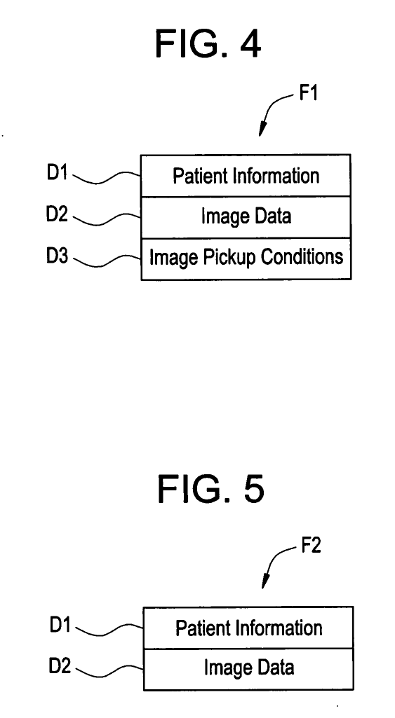

FIG. 4 is a schematic diagram showing the data structure of an image-related file with image pickup conditions.

FIG. 5 is a schematic diagram showing the data structure of an image-related file.

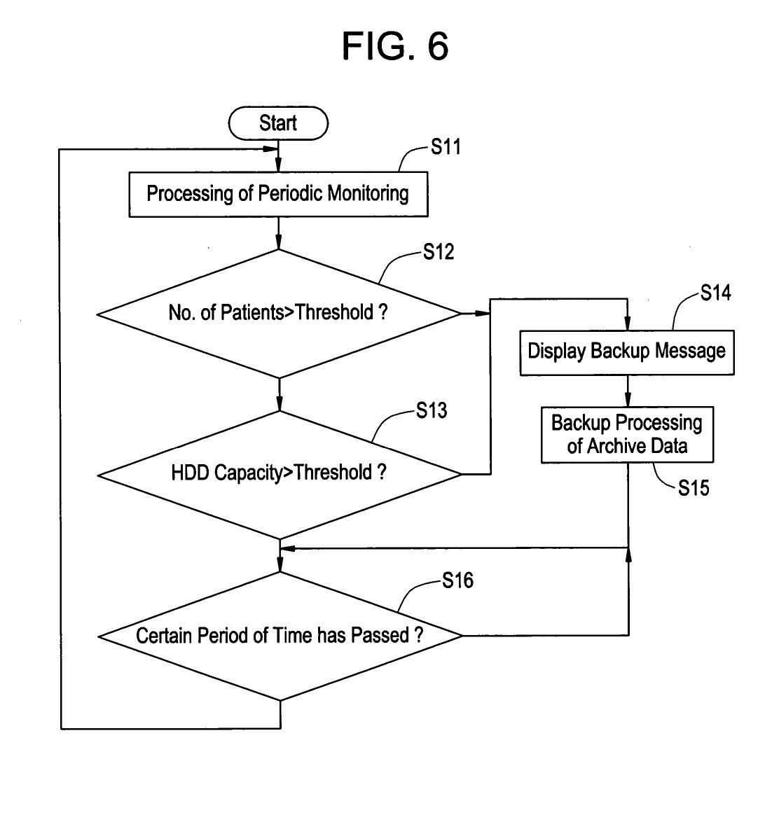

FIG. 6 is a flow chart showing the flow of processing to automatically back up archive data.

### DETAILED DESCRIPTION OF THE INVENTION

A diagnostic imaging apparatus and program pertaining to the present invention in the best modes for implementation will be described in detail below with reference to the accompanying drawings.

One mode for implementing the invention will now be described with reference to FIG. 1 through FIG. 6. This mode for implementation is a case in which an ultrasound diagnostic apparatus is used as the diagnostic imaging apparatus.

FIG. 1 is a perspective view schematically showing an ultrasound diagnostic apparatus 100 in this mode for implementation. As shown in FIG. 1, the ultrasound diagnostic apparatus 100 is provided with an ultrasonic probe 1 which transmits an ultrasonic pulse into a subject (the body of a patient) and receives an ultrasonic echo from within the subject, an ultrasound diagnostic apparatus body 2 which generates an ultrasonic image on the basis of the ultrasonic echo, and a display device 3 which displays the ultrasonic image.

The ultrasound diagnostic apparatus body 2 is provided with an operation panel 4 which accepts the operator's instructions, an internal storage device 5 which is the main storage device for storing an image-related file F1 (see FIG. 4) or an image-related file F2 (see FIG. 5) with image pickup conditions, and a recording/reproducing device 6 which is an auxiliary storage device, with a portable recording medium M such as a DVD or the like detachably built into it, for recording and reproducing files F1 and F2 onto or out of the portable recording medium M. The internal storage device 5 is, for instance, an HDD (hard disk drive).

Specific image pickup conditions include, for example, the type of the ultrasonic probe 1 used for image pickup (e.g. linear electron scanning, sector electron scanning, mechanical electron scanning or convex electron scanning), the frequency of the ultrasonic pulse, the dynamic range defining the range of received echo intensity, the gain defining the relative amplification of received echo intensity, the velocity scale range defining the range of spectral display according to the velocity of blood flow, the gray map used as the conversion map for displaying received echo signals in different shades of gray, the color map for use as the conversion map for color displaying, the color area position defining the position of the interest area cursor for color Doppler signal detection, the sample volume position defining the detecting position for acquiring Doppler blood current signals, and the time scale range defining the time width per unit pixel.

On the operation panel 4, there are arranged an image list button BM for instructing the displaying of an image list (not shown) of previously obtained ultrasonic images, a record button B1 with image pickup conditions for instructing the storing of the image-related file F1 with image pickup conditions, an image pickup condition recall button B2 for reading and setting the image pickup conditions contained in image-related file F1 with image pickup conditions, a record button BR for instructing the storing of the image-related file F2, a freeze button BF for instructing the displaying of an ultrasonic image in a frozen state, an enlarged display button BL for instructing enlarged displaying an ultrasonic image, and a track ball TR for moving the position of the cursor or the like.

Next, the hardware configuration of each unit built into the ultrasound diagnostic apparatus 100 will be described with reference to FIG. 2. As shown in FIG. 2, the ultrasound diagnostic apparatus 100 is provided with a CPU (central processing unit) 10 which is the main unit of the computer and controls each unit. A read only memory ROM 11, which is a memory dedicated to reading, and a RAM (random access memory) 12, which rewritably stores various data, are connected by a bus 13 to this CPU 10 to constitute a microcomputer. The RAM 12, since it has a character to rewritably store various data, functions as the working area of the CPU 10 and performs the role of a buffer or the like.

Further, a transmission/reception control unit 14, a signal processing unit 15 and a DSC 16 are connected to the bus 13 in addition to the aforementioned display device 3, operation panel 4, recording/reproducing device 6 and internal storage device 5.

The transmission/reception control unit 14, to which the ultrasonic probe 1 is connected, so varies the sonic line directions as to two-dimensionally scan the inside of the subject and at the same time acquires sonic line signals in each sonic line direction.

The signal processing unit 15 performs normal B mode processing to generate image data of signal intensity images of signal components of the same frequency as the transmit frequency out of the signal components of the ultrasonic echo, harmonic B mode processing to generate image data of signal intensity images of signal components of double the frequency of the transmit frequency out of the signal components of the ultrasonic echo, CF (Color Flow) mode processing to generate image data based on the phase of the Doppler components of the ultrasonic echo, and PD (Power Doppler) mode processing to generate image data based on the power of the Doppler components of the ultrasonic echo.

The DSC 16 performs format conversion of image data generated by the signal processing unit 15 into a screen format.

Incidentally, the OS (Operating System) and various programs can be stored in the portable recording medium M. The CPU 10 reads programs stored in the portable recording medium M by driving the recording/reproducing device 6, and installs them into the internal storage device 5. Thus, the OS and various programs can be stored in the internal storage device 5 in addition to the files F1 and F2.

Incidentally, as the portable recording medium M, not only a DVD but also a medium of any various other types including various optical disks including the CD, various magneto-optical disks, various magnetic disks such as the flexible disk, the semiconductor memory and the removable hard disk can be used. In this case, the recording/reproducing device 6 should be adapted to the medium to be used. It is also possible to download a program from the Internet or the like and install it into the internal storage device 5. In this case, the storage device in which the program is stored by the server on the transmitting side also is a recording medium according to this invention. Incidentally, the program may be what operates on a prescribed OS (Operating System), in which case some of the various ways of processing to be described afterwards may be delegated to the OS, or may be included as a part of a group of program files constituting prescribed application software and the OS.

Thus, the CPU 10 controlling the overall operation of the ultrasound diagnostic apparatus 100 executes various ways of processing on the basis of programs loaded on the internal storage device 5 used as the main storage device of this apparatus.

Hereupon, the archive processing of an ultrasonic image, which is basic processing to be executed by the CPU 10 in accordance with a program installed in the internal storage device 5 of the ultrasound diagnostic apparatus 100, will be briefly described with reference to the flow chart of FIG. 3.

First, when the operator places the ultrasonic probe 1 against the affected part of the subject, an ultrasonic image is displayed on the display device 3 on a real time basis (step S1), and the real time displaying is continued until it is judged that the freeze button BF has been pressed (Y at step S2).

After that, as the operator presses the freeze button BF the moment the ultrasonic image to be archived is displayed on the screen of the display device 3, if it is judged that the freeze button BF has been pressed (Y in step S2), the ultrasonic image is displayed in a frozen state on the display device 3 (step S3).

In this state the operator, after confirming the ultrasonic image displayed in the frozen state, presses the record button B1 or the record button BR with image pickup conditions. Thus, if it is judged that the image pickup conditions need to be saved in addition to the ultrasonic image, he will press the record button B1 with image pickup conditions or, if it is judged that preservation of the ultrasonic image would be sufficient, he will press the record button BR.

If it is judged at step S4 that the record button B1 with image pickup conditions has been pressed, the operation will proceed to step S5 or, if it is judged that the record button BR has been pressed, it will proceed to step S6.

At step S5, the image-related file F1 with image pickup conditions is stored into the internal storage device 5. As shown in FIG. 4, the image-related file F1 with image pickup conditions has a data structure in which patient information D1, image data D2 on the ultrasonic image and image pickup conditions D3 are associated with one another. Incidentally, image characteristics information including the image size and the type of image format may be stored in addition.

At step S6, the image-related file F2 is stored into the internal storage device 5. As shown in FIG. 5, the image-related file F2 has a data structure in which patient information D1 and image data D2 on the ultrasonic image are associated with each other.

Next, characteristic functions the ultrasound diagnostic apparatus 100 in this mode for implementation has, out of the functions which various programs installed in the internal storage device 5 of the ultrasound diagnostic apparatus 100 cause the CPU 10 to execute, will be described. Herein, the function to automatically back up archive data will be described.

FIG. 6 is a flow chart showing the flow of processing to automatically back up archive data, in which the function to automatically back up archive data is exerted, will be described.

As shown in FIG. 6, the CPU 10 executes processing of periodic monitoring (step S11). Herein, the processing of periodic monitoring in this mode for implementation is processing to monitor in a fixed period whether or not the total of the numbers of patients in the files F1 and F2 stored in the internal storage device 5 exceeds its threshold and whether or not the used data capacity of the internal storage device 5 exceeds its threshold. Incidentally, these thresholds are defined in advance by the user or set at the time of shipping from the factory or on a similar occasion, and stored in the internal storage device 5.

The CPU 10, if as a result of periodic monitoring it has judged that the total of the numbers of patients in the files F1 and F2 stored in the internal storage device 5 exceeds its threshold (Y at step S12: backup judgment means) or that the used data capacity of the internal storage device 5 exceeds its threshold (Y at step S13: backup judgment means), it executes processing of automatic backing-up of archive data (step S15: backup means) after displaying on the display device 3 that it will automatically back up the archive data (step S14: backup notification means). This displaying on the display device 3 of a backup message to the effect that archive data will be automatically backed up can make the user aware of the execution of a backup operation.

The processing to automatically back up archive data at step S15 is processing to transmit, after transmitting part or the whole of the files F1 and F2 stored in the internal storage device 5 to the recording/reproducing device 6 to have them recorded in the portable recording medium M, to erase the files F1 and F2 recorded in the portable recording medium M out of the recording/reproducing device 6. The volume of the files F1 and F2 transmitted to the recording/reproducing device 6 may be determined according to the available storage capacity in the portable recording medium M or predetermined, or only the volume in excess of the threshold may be transmitted to the recording/reproducing device 6 as it arises.

To add, the items to be monitored in the processing of periodic monitoring are not limited to whether or not the total of the numbers of patients in the files F1 and F2 stored in the internal storage device 5 exceeds its threshold and whether or not the used data capacity of the internal storage device 5 exceeds its threshold. For instance, it may be monitored whether or not the size of image data generated by the signal processing unit 15 exceeds its threshold and, if the size of the generated image data exceeds its threshold, the processing to automatically back up archive data may be executed before storing the image data into the internal storage device 5. Here is realized backup judgment means.

The execution of processing from steps S11 through S15 described above will be repeated if a certain period of time has passed after the start of step S11 (Y at step S16).

It is also possible to also equip the recording/reproducing device 6 a function to monitor the capacity of the portable recording medium M (monitoring means) and have the CPU 10, when the available storage capacity in the portable recording medium M has become scarce, display on the display device 3 a notification that the available storage capacity in the portable recording medium M has become scarce, thereby to urge the operator to replace the portable recording medium M (notification means). By monitoring the available storage capacity in the portable recording medium M in the recording/reproducing device 6 in this way and, when it is judged that the available storage capacity in the portable recording medium M has become scarce, notifying the recording/ reproducing device 6 of the scarcity of the available storage capacity, it is possible to avoid a situation in which neither a part of nor the whole of the group of image files stored in the internal storage device 5 cannot be backed up in the recording/reproducing device 6.

As described above, if it is judged by the backup judgment means that backing up is to be done, a part or the whole of the group of image files stored in the internal storage device 5 are transmitted to and recorded in the recording/reproducing device 6 provided separately from the internal storage device 5, and image files recorded in the recording/reproducing device 6 are erased from the internal storage device 5. In this way, without forcing the user to perform troublesome periodic backing-up, a part or the whole of the group of image files stored in the internal storage device 5 can be backed up automatically in an auxiliary storage device, and at the same time the system performance can be prevented from deterioration by reducing the load on the internal storage device 5.

Further the backup means, by recording a part or the whole of the transmitted group of image files in the portable recording medium M detachably built into the recording/reproducing device 6, facilitates replacement and post-backup conservation when the available storage capacity in the portable recording medium M in the recording/reproducing device 6 has become scarce.

To add, though the description of this mode for implementation has referred to a case in which an ultrasound diagnostic apparatus is applied as the diagnostic imaging apparatus, the apparatus is not limited to this, but an X-ray CT apparatus or an MRI apparatus may as well be applied as the diagnostic imaging apparatus.

Many widely different embodiments of the invention may be configured without departing from the spirit and the scope of the present invention. It should be understood that the present invention is not limited to the specific embodiments described in the specification, except as defined in the appended claims.

1. A diagnostic imaging apparatus which stores in a main storage device files containing image data, generated on the basis of signals from a subject, regarding the subject, the diagnostic imaging apparatus comprising:
an auxiliary storage device provided separately from said main storage device;
a backup judgment device which judges whether or not a part or the whole of a group of said files stored in said main storage device is to be backed up in said auxiliary storage device; and
a backup device which, when this backup judgment device has judged that backup is to be performed, transmits and records a part or the whole of the group of said image files stored in said main storage device to and in said auxiliary storage device and erases said image files recorded in said auxiliary storage device from said main storage device.

2. The diagnostic imaging apparatus according to claim 1, further comprising:
a backup notification device which, when said backup judgment device has judged that backup is to be performed, gives a notification to the effect that a part or the whole of the group of said image files stored in said main storage device will be backed up.

3. The diagnostic imaging apparatus according to claim 1, further comprising:
a monitoring device which monitors the available storage capacity in said auxiliary storage device; and
a notification device which, when it is judged by this monitoring device that the available storage capacity in said auxiliary storage device has become scarce, gives a notification to the effect that the available storage capacity in said auxiliary storage device has become scarce.

4. The diagnostic imaging apparatus according to claim 1, wherein:
said backup judgment device judges whether or not a part or the whole of the group of said image files stored in said main storage device is to be backed up in said auxiliary storage device according to whether or not the total number of subjects pertaining to said image files stored in said main storage device exceeds the threshold thereof.

5. The diagnostic imaging apparatus according to claim 1, wherein:
said backup judgment device judges whether or not a part or the whole of the group of said image files stored in said main storage device is to be backed up in said auxiliary storage device according to whether or not the used data capacity of said main storage device exceeds the threshold thereof.

6. The diagnostic imaging apparatus according to claim 1, wherein:
said backup judgment device judges whether or not a part or the whole of the group of said image files stored in said main storage device is to be backed up in said auxiliary storage device according to whether or not the size of image data generated pertaining to said subject exceeds the threshold thereof.

7. The diagnostic imaging apparatus according to claim 1, wherein:
said auxiliary storage device can record into a detachably built-in portable recording medium; and
said backup device records a part or the whole of said group of image files into said portable recording medium built into said auxiliary storage device.

8. A program readable by a computer for controlling a diagnostic imaging apparatus which stores in a main storage device files containing image data, generated on the basis of signals from a subject, regarding the subject, the program causing said computer to execute:
a backup judgment function to judge whether or not a part or the whole of a group of said files stored in said main storage device is to be backed up in an auxiliary storage device provided separately from said main storage device; and
a backup function to transmit and record, when this backup judgment device has judged that backup is to be performed, a part or the whole of the group of said image files stored in said main storage device to and in said auxiliary storage device and to erase said image files recorded in said auxiliary storage device out of said main storage device.

9. The program according to claim 8, causing said computer to execute a backup notifying function to give, when it has been judged by said backup judgment function that backup is to be performed, a notification to the effect that a part or the whole of the group of said image files stored in said main storage device will be backed up.

10. The program according to claim 8, causing said computer to execute:
a monitoring function to monitor the available storage capacity in said auxiliary storage device; and
a notifying function to give, when it is judged by this monitoring function that the available storage capacity in said auxiliary storage device has become scarce, a notification to the effect that the available storage capacity in said auxiliary storage device has become scarce.
